(19) United States
(12) Patent Application Publication
(10) Pub. No.: US 2008/0024794 A1
(43) Pub. Date: Jan. 31, 2008

(54) Semiconductor Surface Inspection Apparatus and Method of Illumination

(76) Inventors: Yoko Miyazaki, Tokyo (JP); Toshiro Kurosawa, Tokyo (JP); Muneaki Tamura, Tokyo (JP)

Correspondence Address: CHRISTIE, PARKER & HALE, LLP, PO BOX 7068, PASADENA, CA, 91109-7068, US

(21) Appl. No.: 11/628,548

(22) PCT Filed: Jun. 3, 2005
(86) PCT No.: PCT/JP05/10625

§ 371 Date: Dec. 4, 2006

(30) Foreign Application Priority Data
Jun. 4, 2004 (JP) 2004-167130

(51) Int. Cl. G01B 11/24

(52) U.S. Cl. 356/612

(57) ABSTRACT

In a semiconductor surface inspection apparatus for inspecting the surface of a semiconductor device as a test object based on an optical image thereof, the present invention achieves illumination that enables diffracted light from the test object under dark-field illumination to be obtained efficiently from the entire area of the test object and thereby alleviates degradation of the defect detection sensitivity of the inspection apparatus over the entire area of the test object. For this purpose, dark-field illumination is performed using a semiconductor light-emitting device array comprising a plurality of semiconductor light-emitting devices which differ in emission wavelength, incident angle with respect to the test object, or azimuth angle of illumination light to the test object, and a light-emission control section performs light-emission control by selecting from the semiconductor light-emitting device array the semiconductor light-emitting devices that provide the illumination light having the emission wavelength, incident angle, or azimuth angle suitable for inspecting each designated portion on the test object.

### CROSS-REFERENCE TO A RELATED APPLICATION

This application is a National Phase Patent Application of International Patent Application Number PCT/JP2005/010625, filed on Jun. 3, 2005, which claims priority of Japanese Patent Application Number 2004-167130, filed on Jun. 4, 2004.

### TECHNICAL FIELD

The present invention relates to a semiconductor surface inspection apparatus for inspecting the surface of a semiconductor device, such as a semiconductor wafer, a photomask, a liquid crystal display panel, or the like, based on a captured optical image of the semiconductor device.

### BACKGROUND ART

The manufacturing process of a semiconductor device, such as a semiconductor wafer, a photomask, a liquid crystal display panel, or the like, comprises a large number of steps, and it is important, from the standpoint of improving the manufacturing yield, to inspect the device for defects at the final stage of manufacture or at an intermediate stage and to feed the resultant defect information back to the manufacturing process. To detect such defects, a surface inspection apparatus is widely used to generate an optical image of a circuit pattern formed during the manufacturing process on a test object, such as a semiconductor wafer, a photomask, a liquid crystal display panel, or the like, and to detect any pattern defect on the test object by inspecting the optical image.

The following description will be given by taking, as an example, a semiconductor wafer surface inspection apparatus for inspecting defects in a pattern formed on a semiconductor wafer. However, the present invention is not limited to this particular type of apparatus, but can be widely applied to surface inspection apparatus for inspecting semiconductor memory photomasks, liquid crystal display panels, and other semiconductor devices.

In the above surface inspection apparatus, generally, an optical microscope is used to generate an optical image of a circuit pattern formed on the surface of a semiconductor wafer to be inspected. There are two types of optical microscope, the bright-field microscope and the dark-field microscope, depending on the method of microscope illumination, and either type can be used in the semiconductor surface inspection apparatus.

FIG. 1A is a diagram showing the basic configuration of an optical image generating section that uses a bright-field microscope. The optical image generating section comprises: a stage 41 for holding a semiconductor wafer 1 thereon; a light source 21; illumination lenses 22 and 23 for converging illumination light emitted from the light source 21; a beam splitter 24 for reflecting the illumination light; an objective lens 10 for focusing the illumination light onto the surface of the semiconductor wafer 1 and for projecting an optical image captured of the surface of the semiconductor wafer 1; and an imaging device 31 for converting the projected optical image of the surface of the semiconductor wafer 1 into an electrical image signal. Generally, in the illumination system (bright-field illumination system) used for the bright-field microscope, the direction of the illumination light projected onto the surface of the semiconductor wafer 1 is substantially parallel to the optical axis of the objective lens 10, and thus the objective lens 10 captures the light specularly reflected at the surface of the semiconductor wafer 1.

A TV camera or the like that uses a two-dimensional CCD device may be used as the imaging device 31, but a line sensor such as a one-dimensional CCD is often used in order to obtain a high-definition image signal; in that case, the stage 41 is moved (scanned) relative to the semiconductor wafer 1, and an image processor 33 acquires the image by capturing the signal of the line sensor 31 in synchronism with the drive pulse signal that a pulse generator 42 generates to drive the stage 41.

FIG. 1B is a diagram showing the basic configuration of an optical image generating section that uses a dark-field microscope. The component elements similar to those in FIG. 1A are designated by the same reference numerals, and the description thereof will not be repeated. In the dark-field microscope, the objective lens 10 captures scattered light or diffracted light of the illumination light scattered or diffracted at the surface of the semiconductor wafer 1. Here, the illumination light is projected obliquely with respect to the optical axis of the objective lens from a portion encircling the periphery of the objective lens, thus preventing specularly reflected illumination light from entering the objective lens 10.

For this purpose, the illumination system (dark-field illumination system) used for the dark-field microscope of FIG. 1B includes: a ring slit 26 which blocks the illumination light emitted from the light source 21 but allows the peripheral portion of the light to pass through; a ring mirror 27 which reflects the light passed through the ring slit 26 into the direction of the object under inspection, while allowing the light projected from the objective lens 10 to pass through; and a ring-shaped condenser 28 which is arranged so as to encircle the periphery of the objective lens 10 and which converges the illumination light and projects the light obliquely with respect to the optical axis of the objective lens 10 from the portion encircling the periphery of the objective lens 10.

As described above, while the bright-field microscope obtains an image formed by the specularly reflected light of the illumination light projected onto the test object, the dark-field microscope obtains an image produced by the scattered or diffracted light of the illumination light projected onto the test object. Accordingly, the dark-field microscope has the advantage that high-sensitivity defect detection can be achieved using a relatively simple configuration, because the light irregularly reflected by a defect on the surface can be accentuated.

Prior art illumination systems used for optical microscopes are disclosed in Japanese Unexamined Patent Publication Nos. H07-218991, H08-36133, H08-101128, H08-166514, H08-211327, H08-211328, H10-90192, and 2002-174514, Japanese Patent No. 3249509, and U.S. Pat. No. 6,288,780.

### DISCLOSURE OF THE INVENTION

Patterns of various configurations are formed on the test object, i.e., the semiconductor wafer 1. FIG. 2 is a schematic diagram showing the various patterns formed on the wafer 1. An area 3, for example, is a cell area having a wiring pattern of parallel lines formed at a relatively large pitch and extending vertically in the figure, while an area 4 is a cell area having a wiring pattern of parallel lines formed at a relatively small pitch and extending vertically in the figure. On the other hand, an area 5 is a cell area having a wiring pattern oriented obliquely at an angle of 45° in the plane of the figure, and an area 6 is a logic circuit area whose pattern density is low compared with the cell areas. A peripheral circuit pattern (peripheral) area for interconnecting the above circuits is also formed on the wafer 1.

However, in the prior art surface inspection apparatus, the dark-field illumination system has been designed to provide illumination light which is omnidirectional in azimuth or is fixed to one particular azimuth angle relative to the objective lens 10, and the wavelength and the incident angle of the illumination light have also been fixed. As a result, the illumination light having a fixed wavelength has been projected at the same azimuth angle and at the same incident angle, regardless of in which of the areas 3 to 6 the field of view of the objective lens 10 is located, and, as a result, the prior art has had the following problems.

First, if the optical image of the test object is to be acquired at high throughout, the amount of light introduced into the imaging device 31 must be increased. However, as the dark-field microscope does not utilize the specularly reflected light of the illumination light, the amount of light entering the objective lens 10 is smaller than in the bright-field microscope, and therefore, how efficiently the diffracted light diffracted by the test object is utilized is important.

Here, the optical reflectance of an object depends on the material of the object. For example, copper used for wiring in a semiconductor circuit has the property that it exhibits high reflectance in the visible region of the spectrum but its reflectance drops in the wavelength region near 350 nm.

Accordingly, with the illumination light having a fixed wavelength described above, as the ratio of the area occupied by the material varies according to the density of the pattern, the amount of light that can be utilized drops depending on the site under inspection. Further, when patterns of different materials are formed on the test object in different manufacturing steps, the reflectance varies and the amount of light that can be utilized drops depending on the step in which the inspection is performed.

Furthermore, in a repeated pattern area where many parallel lines are formed in a repeated fashion as in a wiring pattern formed on a semiconductor wafer, the angular difference between the diffracted light and the specularly reflected light depends on the repeat pitch of the repeated pattern and the wavelength of the illumination light. Accordingly, when, for example, the wiring pitch of parallel line patterns differs depending on the position on the test object such as a chip, as is the case with semiconductor device wafer patterns (that is, as in the case of the areas 3 and 4 shown in FIG. 2), there occurs the problem that, when illumination light having a fixed incident angle and fixed wavelength such as described above is projected, the major portion of the diffracted light may be made to enter the objective lens for a parallel line pattern area having a certain wiring pitch but, for a parallel line pattern area having a different wiring pitch, a sufficient amount of diffracted light may not be directed to the objective lens, resulting in an inability to effectively utilize the diffracted light.

Second, when illumination light is projected onto a line pattern area formed on a semiconductor wafer from an azimuth angle corresponding to a lateral direction relative to the line direction, the intensity of the scattered light reflected at the edges of the lines increases, and the signal strength of the scattered light associated with a defect (short-circuiting) or a foreign particle present between lines relatively decreases, resulting in degradation of the detection sensitivity. Accordingly, when the surface of a test object on which line patterns extending in different directions are formed is illuminated with the illumination light having a fixed illumination direction described above, there arises the problem that the detection sensitivity drops depending on the pattern direction.

Third, when a high-density pattern area such as a memory cell area and a low-density pattern area such as its peripheral circuit area or logic circuit area are formed on the surface of the test object, i.e., the semiconductor wafer, if both areas are illuminated with the same amount of light there arises the problem that the difference in brightness between the captured images becomes large and, when the difference exceeds the detection dynamic range of a detector, the detection sensitivity in one or the other of the areas drops.

In view of the above problems, in a semiconductor surface inspection apparatus for inspection the surface of a semiconductor device as a test object based on an optical image thereof, it is an object of the present invention to achieve illumination that enables diffracted light effective for the inspection of the test object under dark-field illumination to be obtained efficiently from the entire area of the test object and to thereby alleviate degradation of the defect detection sensitivity of the inspection apparatus over the entire area of the test object.

To achieve the above object, in accordance with the present invention, dark-field illumination is performed using a semiconductor light-emitting device array comprising a plurality of semiconductor light-emitting devices which differ in emission wavelength, incident angle with respect to the test object, or azimuth angle of illumination light to the test object, and light-emission control is performed by selecting from the semiconductor light-emitting device array the semiconductor light-emitting devices that provide the illumination light having the emission wavelength, incident angle, or azimuth angle suitable for inspecting each designated portion on the test object.

That is, according to a first mode of the present invention, there is provided a semiconductor surface inspection apparatus for inspecting a surface on a semiconductor device as a test object based on an optical image of the test object, comprising: a semiconductor light-emitting device array formed by a plurality of semiconductor light-emitting devices for illuminating the test object obliquely with respect to the optical axis of an objective lens; and a light-emission control section for performing control so as to selectively turn on the semiconductor light-emitting devices in the semiconductor light-emitting device array.

Further, according to a second mode of the present invention, there is provided, for use in a semiconductor surface inspection apparatus for inspecting a surface on a semiconductor device as a test object based on an optical image of the test object, an illumination method for illuminating the test object, wherein control is performed so as to selectively turn on a plurality of semiconductor light-emitting devices contained in a semiconductor light-emitting device array which is configured to illuminate the test object obliquely with respect to the optical axis of an objective lens.

The light-emission control section may change the amount of light emission of each individual one of the selectively turned-on semiconductor light-emitting devices. Further, in the semiconductor surface inspection apparatus according to the first mode of the present invention as well as in the illumination method according to the second mode, all the semiconductor light-emitting devices contained in the semiconductor light-emitting device array may be turned on or off simultaneously, rather than selecting them individually.

Furthermore, the semiconductor light-emitting device array may include a plurality of semiconductor light-emitting devices that differ in the incident angle at the test object, the emission wavelength, and/or the azimuth angle of the illumination light (i.e., the illumination direction in the plane perpendicular to the optical axis of the objective lens).

In this case, the light-emission control section may selectively turn on the semiconductor light-emitting devices so as to change the incident angle of the illumination light with respect to the test object, the wavelength of the illumination light for illuminating the test object, and/or the azimuth angle of the illumination light for illuminating the test object.

The light-emission control section may select one or more semiconductor light-emitting devices from the semiconductor light-emitting device array and change the amount of light emission of the selected semiconductor light-emitting devices. Here, the light-emission control section may change the amount of light emission of the selected semiconductor light-emitting devices thereby changing the amount of incident light for each incident angle of the illumination light with respect to the test object, each wavelength of the illumination light, or each azimuth angle of the illumination light for illuminating the test object.

The light-emission control section may select the semiconductor light-emitting devices to be turned on so as to match a portion on the test object that is currently located in the field of view of the objective lens. For this purpose, the semiconductor surface inspection apparatus may include storage means for storing device-specific information which is predetermined for each portion of the test object and which specifies each of the semiconductor light-emitting devices to be turned on, or device-specific information which specifies each semiconductor light-emitting device that matches the illumination conditions specified for each portion of the test object, and the light-emission control section may select each semiconductor light-emitting device specified by the device-specific information as matching the portion currently located in the field of view of the objective lens and may perform control so as to switch between the semiconductor light-emitting devices in accordance with the illumination conditions specified for that portion.

The device-specific information may include information classifying pattern areas according to the repeat pitch width of a repeated pattern formed on each portion of the test object, the pitch width of a wiring pattern, the orientation of a line pattern, and/or the material of the pattern formed on each portion of the test object.

The semiconductor surface inspection apparatus may include a moving stage for holding the test object thereon, the moving stage being capable of positioning each designated portion of the test object within the field of view of the objective lens. In this case, the light-emission control section may identify, based on the position information (position trigger information) of the moving stage, the portion of the test object that is currently located within the field of view of the objective lens. Prior to the start of the inspection, the light-emission control section may turn on the semiconductor light-emitting devices selected so as to provide optimum illumination conditions that match the arrangement of the pattern formed on the portion in the inspection start position on the test sample; thereafter, as the moving stage moves during the inspection, the light-emission control section may acquire, based on the position information of the moving stage, the information classifying the pattern areas according to the repeat pitch width of the repeated pattern, the pitch width of the wiring pattern, the orientation of the line pattern, and/or the material of the pattern, and may perform switching dynamically based on the classifying information so as to provide optimum illumination conditions throughout the inspection.

The semiconductor surface inspection apparatus may further include bright-field illumination means for illuminating the test object in a direction parallel to the optical axis of the objective lens. The light-emission control section may control the light emission of the semiconductor light-emitting device array so as to match the portion of the test object that is currently located in the field of view of the objective lens.

According to the present invention, the incident angle, wavelength, and/or azimuth angle of the illumination light for illuminating the test object can be changed and the amount of light adjusted during the inspection, and the test object can thus be illuminated with optimum illumination light that matches each portion formed on the test object. As a result, diffracted light from the test object under dark-field illumination can be obtained efficiently from the entire area of the test object, which serves to alleviate degradation of the defect detection sensitivity of the inspection apparatus over the entire area of the test object.

By using the semiconductor light-emitting devices as the illuminating means, the incident angle, wavelength, and/or azimuth angle of the illumination light can be changed and the amount of light adjusted almost instantaneously by switching signals electrically, not mechanically. Further, as the amount of light of each semiconductor light-emitting device can be easily controlled, the amount of light can be adjusted to match the pattern formed on each portion of the test object or its pattern density. Furthermore, compared with externally mounted lasers such as commonly used Ar+ lasers, not only can the cost of the illumination system itself be reduced, but the maintenance cost can also be reduced because of the long service life of the device itself.

Further, when a plurality of monochromatic beams are used as the illumination light, then a plurality of defects having high spectral reflectance, which differs depending on the constituent material, can be detected simultaneously in a single inspection operation by projecting such monochromatic beams at once. Furthermore, with the provision of the bright-field illumination means, while illuminating the test object with bright-field illumination that provides the lightness advantageous for the observation of the pattern formed thereon, defects in the pattern can be accentuated with the illumination light from the semiconductor light-emitting device array that provides dark-field illumination; this serves to enhance the defect detection sensitivity.

Further, when the field of view of the objective lens is located in a low-density pattern area, the semiconductor light-emitting device array is turned off and the test object is illuminated only with the bright-field illumination means, while on the other hand, when the field of view of the objective lens is located in a high-density pattern area, and sufficient brightness of reflected light cannot be obtained with the bright-field illumination alone, the semiconductor light-emitting device array is turned on in addition to the bright-field illumination means; by so doing, high detection sensitivity can be achieved over the entire area of the test object even when low-density and high-density pattern areas are mixed on the test object.

### BRIEF DESCRIPTION OF THE DRAWINGS

FIG. 1A is a diagram showing the basic configuration of an optical image generating section that uses a bright-field microscope.

FIG. 1B is a diagram showing the basic configuration of an optical image generating section that uses a dark-field microscope.

FIG. 2 is a schematic diagram showing various patterns formed on a wafer.

FIG. 3 is a schematic diagram showing the configuration of a semiconductor surface inspection apparatus according to a first embodiment of the present invention.

FIG. 4A is a side cross-sectional view of a semiconductor light-emitting device array mounted inside a case.

FIG. 4B is a diagram for explaining a first example of the arrangement of semiconductor light-emitting devices in the semiconductor light-emitting device array mounted inside the case.

FIG. 4C is a diagram for explaining a second example of the arrangement of the semiconductor light-emitting devices in the semiconductor light-emitting device array mounted inside the case.

FIG. 4D is a diagram for explaining a third example of the arrangement of the semiconductor light-emitting devices in the semiconductor light-emitting device array mounted inside the case.

FIG. 4E is a diagram for explaining a fourth example of the arrangement of the semiconductor light-emitting devices in the semiconductor light-emitting device array mounted inside the case.

FIG. 5 is a diagram showing the direction of reflection of diffracted light diffracted by a repeated pattern.

FIG. 6A is a diagram showing the relationship among defect detection sensitivity, wiring patterns, and azimuth angle of illumination light in a wiring pattern area.

FIG. 6B is a diagram showing an image captured when a wafer shown in FIG. 6A is illuminated with bright-field illumination.

FIG. 6C is a diagram showing an image captured when the wafer is illuminated with oblique illumination from directions A and B shown in FIG. 6A.

FIG. 6D is a diagram showing an image captured when the wafer is illuminated with oblique illumination from direction A shown in FIG. 6A.

FIG. 6E is a diagram showing an image captured when the wafer is illuminated with oblique illumination from direction B shown in FIG. 6A.

FIG. 7A is a side cross-sectional view of the semiconductor light-emitting device array mounted outside the case.

FIG. 7B is a diagram for explaining a first example of the arrangement of the semiconductor light-emitting devices in the semiconductor light-emitting device array mounted outside the case.

FIG. 7C is a diagram for explaining a second example of the arrangement of the semiconductor light-emitting devices in the semiconductor light-emitting device array mounted outside the case.

FIG. 7D is a diagram for explaining a third example of the arrangement of the semiconductor light-emitting devices in the semiconductor light-emitting device array mounted outside the case.

FIG. 7E is a diagram for explaining a fourth example of the arrangement of the semiconductor light-emitting devices in the semiconductor light-emitting device array mounted outside the case.

FIG. 8A is a diagram for explaining a first configuration example for changing the incident angle of the illumination light with respect to test object for each semiconductor light-emitting device.

FIG. 8B is a diagram for explaining a second configuration example for changing the incident angle of the illumination light with respect to test object for each semiconductor light-emitting device.

FIG. 8C is a diagram for explaining a third configuration example for changing the incident angle of the illumination light with respect to test object for each semiconductor light-emitting device.

FIG. 9 is a diagram showing a top plan view of a semiconductor wafer as the test object and an enlarged view of a portion of the wafer.

FIG. 10 is a timing chart for explaining how the light emission of each semiconductor light-emitting device is controlled.

FIG. 11 is a diagram showing the arrangement of the semiconductor light-emitting device array used for scanning shown in FIG. 10.

FIG. 12 is a schematic diagram showing the configuration of a semiconductor surface inspection apparatus according to a second embodiment of the present invention.

FIG. 13 is a timing chart for explaining how the light emission of bright-field illumination means and semiconductor light-emitting devices is controlled.

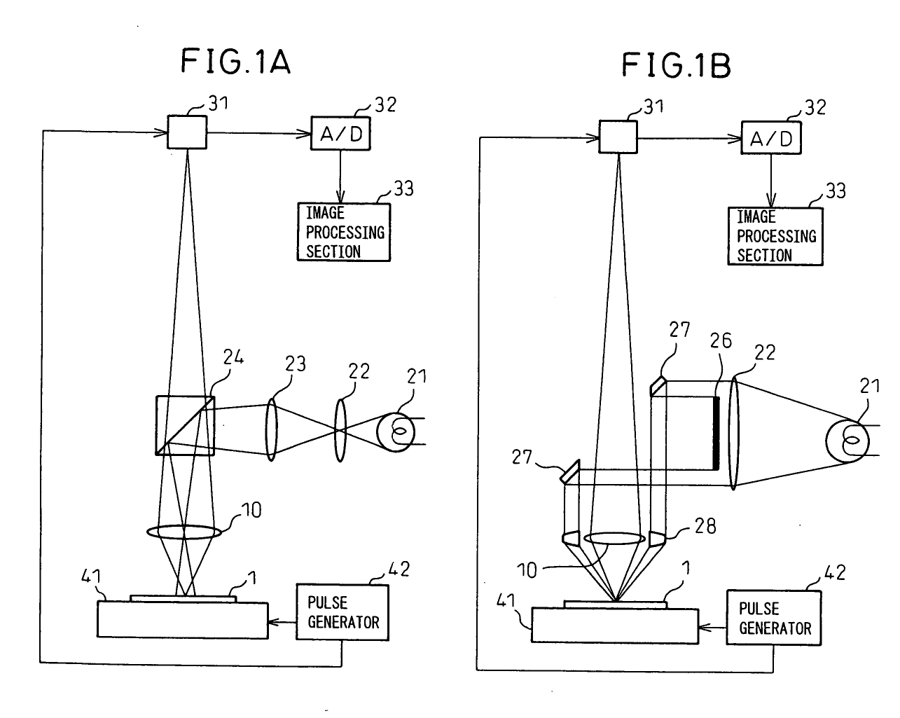

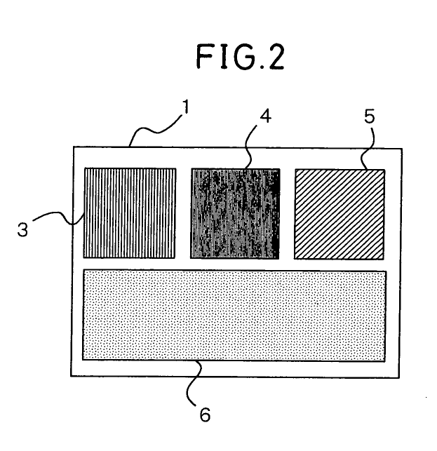

### BEST MODE FOR CARRYING OUT THE INVENTION

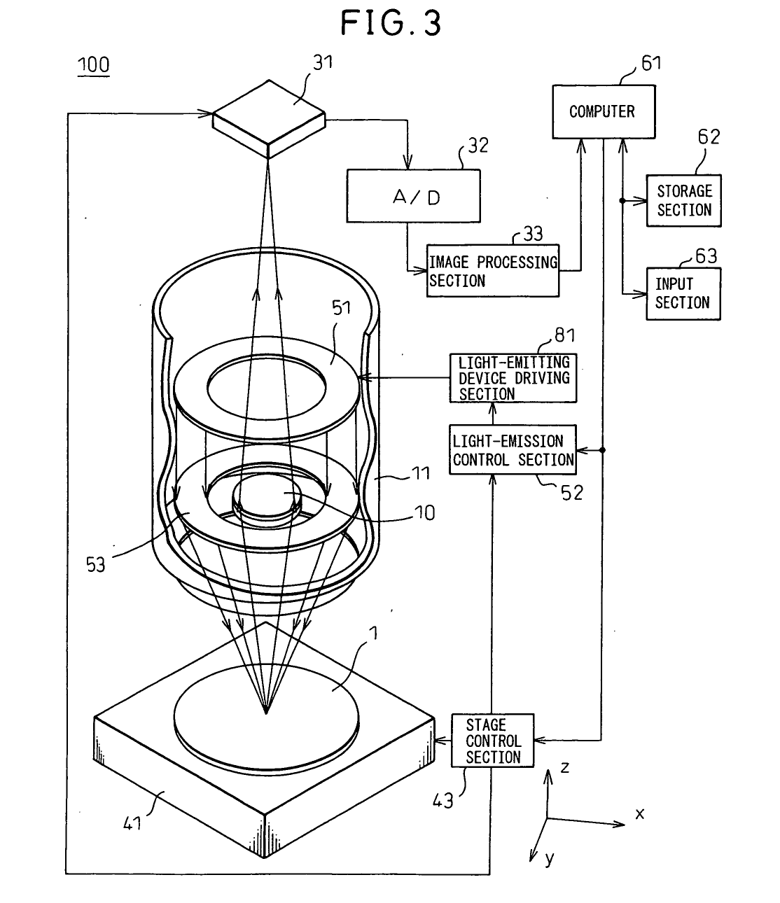

Embodiments of the present invention will be described below with reference to the accompanying drawings. FIG. 3 is a schematic diagram showing the configuration of a semiconductor surface inspection apparatus according to a first embodiment of the present invention. The following description will be given by taking as an example a semiconductor wafer surface inspection apparatus for inspecting defects in a pattern formed on a semiconductor wafer; however, the present invention is not limited to this particular type of apparatus, but can be widely applied to surface inspection apparatus for inspecting semiconductor memory photomasks, liquid crystal display panels, and other semiconductor devices.

The semiconductor surface inspection apparatus 100 comprises: a moving stage 41 for holding a semiconductor wafer 1 thereon; a semiconductor light-emitting device array 51 containing a plurality of semiconductor light-emitting devices forming a light source; a light-emission control section 52 for performing light-emission control by selectively turning on and off the semiconductor light-emitting devices contained in the semiconductor light-emitting device array 51; a light-emitting device driving section 81 for turning on and off each semiconductor light-emitting device based on a control signal supplied from the light-emission control section 52; a ring-shaped illumination lens 53 for converging the illumination light emitted from the semiconductor light-emitting device array 51 and projecting it onto the surface of the wafer 1; an objective lens 10 for projecting an optical image by collecting diffracted light from the illumination light illuminated on the surface of the wafer 1; a cylindrical case 11 for housing the objective lens 10; and an imaging device 31 for converting the projected optical image of the surface of the wafer 1 into an electrical image signal. As the semiconductor light-emitting devices, light-emitting diode (LED) chips or laser diode chips may be used, or alternatively, molded LEDs or laser diodes may be used.

As shown, the semiconductor light-emitting device array 51 and the illumination lens 53 are arranged and centered about the optical axis of the objective lens 10 within the case 11, and the illumination light from the semiconductor light-emitting devices provides dark-field illumination in which the light is projected toward the wafer 1 obliquely with respect to the optical axis of the objective lens 10 from the portion encircling the periphery of the objective lens 10. For purposes of explanation, the plane containing the inspection surface of the test object (the surface of the wafer 1) and perpendicular to the optical axis of the objective lens 10 is hereinafter referred to as the xy plane, and the direction of the optical axis of the objective lens 10 is taken as the z direction.

The semiconductor surface inspection apparatus 100 includes a stage control section 43 which performs positioning control for positioning each designated portion on the surface of the wafer 1 within the field of view of the objective lens 10 by driving the moving stage 41.

A TV camera or the like that uses a two-dimensional CCD device may be used as the imaging device 31, but in the present embodiment, a line sensor such as a one-dimensional CCD is used. The stage control section 43 outputs a drive pulse signal to the moving stage 41 which is thus moved (scanned) relative to the wafer 1. At this time, the line sensor 31 outputs an analog image signal in synchronism with the drive pulse signal output from the stage control section 43, and the analog image signal is converted by an analog/digital converter 32 into a digital signal, based on which an image processing section 33 constructs two-dimensional image data.

The entire operation of the semiconductor surface inspection apparatus 100 is controlled by a computing device 61 which can be implemented by a computer or the like. The semiconductor surface inspection apparatus 100 further includes a storage section 62 for storing programs and data necessary for controlling by the computing device 61, as well as device-specific information to be described later, and an input section 63 for entering the programs and data. The two-dimensional image data constructed by the image processing section 33 is supplied to the computing device 61 and used for various kinds of surface inspections.

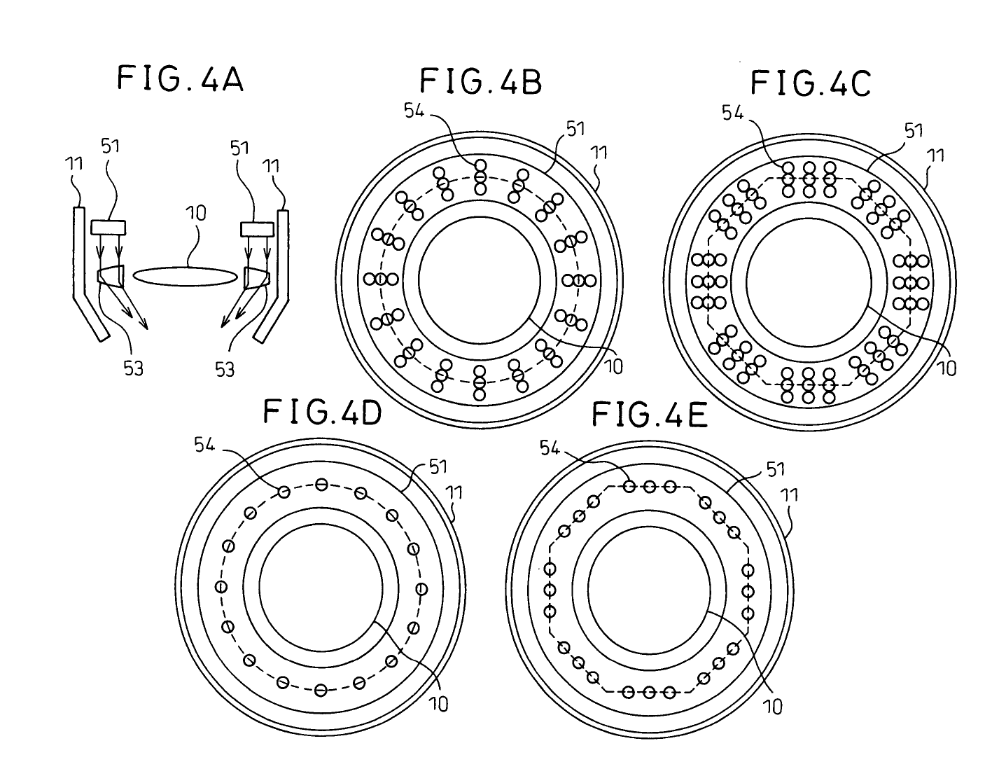

FIG. 4A is an X-Z cross-sectional view showing the interior of the case 11, and FIG. 4B is a diagram for explaining a first example of the arrangement of the semiconductor light-emitting devices in the semiconductor light-emitting device array 51 in the X-Y plane. As shown in FIG. 4B, the semiconductor light-emitting devices 54 are arranged in a plurality of concentric circles (three circles in the figure) centered about the optical axis of the objective lens 10. The illumination light emitted from the respective semiconductor light-emitting devices 54 is converged by the illumination lens 53 as a condenser lens and projected onto the portion of the wafer 1 that lies within the field of view of the objective lens 10.

The semiconductor light-emitting devices 54 are arranged so that the angle of incidence of the illumination light passed through the illumination lens 53 and falling on the wafer 1 (that is, the angle that the direction of incidence of the illumination light makes with the perpendicular dropped to the surface of the wafer 1) differs depending on the radial position of the semiconductor light-emitting devices 54 arranged in the concentric circles. For example, in the present embodiment, the semiconductor light-emitting devices 54 are arranged so that, as shown in FIG. 4A, the angle of incidence decreases (becomes deeper) with a decreasing distance from the optical axis of the objective lens 10, and increases (become shallower) with an increasing distance from the optical axis of the objective lens 10.

On the other hand, the azimuth angle of the illumination light from the semiconductor light-emitting devices 54 to the wafer 1 at the X-Y plane (wafer plane) (that is, the direction of illumination of the illumination light in the X-Y plane) differs depending on the circumferential position of the semiconductor light-emitting devices 54 arranged in the concentric circles. Here, since the direction of the wiring pattern formed on the semiconductor wafer 1 is usually oriented at one of the angles of 0°, 45°, 90°, and 135°, it is preferable that the azimuth angles of the illumination light from the respective semiconductor light-emitting devices 54 be set at least at angles of 0°, 45°, 90°, and 135° (that is, spaced 45° apart from each other) so that the wiring pattern oriented at any one of the angles of 0°, 45°, 90°, and 135° can be illuminated with illumination light projected in the direction parallel to the direction of the wiring pattern orientation. In some rare cases, there are wiring patterns oriented at other angles than the above angles; in such cases, it is preferable to illuminate such pattern by combining a plurality of semiconductor devices having different azimuth angles or a plurality of semiconductor device groups each consisting of semiconductor devices having the same azimuth angle.

Further, the semiconductor light-emitting devices 54 forming the semiconductor light-emitting device array 51 are constructed using a plurality of monochromatic semiconductor light-emitting devices that emit light at difference wavelengths. In other words, the semiconductor light-emitting devices 54 in the semiconductor light-emitting device array 51 form a plurality of groups of different light-emission wavelengths.

Here, each semiconductor light-emitting device 54 may be configured to have a different emission wavelength or, if there is no need to change the wavelength of the illumination light in the semiconductor surface inspection apparatus 100, all the semiconductor light-emitting devices 54 in the semiconductor light-emitting device array 51 may be configured to emit light at the same wavelength.

The storage section 62 stores light-emitting device attribute information as a table of data in which each semiconductor light-emitting device 54 in the semiconductor light-emitting device array 51 is associated with the incident angle, azimuth angle, and emission wavelength of the illumination light for that semiconductor light-emitting device 54, and the attribute information is used in the light-emission control section 52 as will be described later.

The semiconductor light-emitting devices 54 in the semiconductor light-emitting device array 51 may be organized into a plurality of semiconductor light-emitting device groups. Here, the semiconductor light-emitting devices 54 may be grouped by the incident angle, the emission wavelength, and/or the azimuth angle of the illumination light.

Referring again FIG. 3, the stage control section 43 is capable of constantly outputting position information (position trigger information) indicating the current position of the moving stage 41, and the light-emission control section 52 acquires the position information of the moving stage 41 from the stage control section 43. As the mounting position of the wafer 1 on the moving stage 41 is predetermined, the light-emission control section 52 can determine, based on the acquired position information of the moving stage 41, which portion of the wafer 1 is currently located within the field of view of the objective lens 10.

The light-emission control section 52 retrieves the device-specific information entered in advance from an external device via the input section 63 and stored in the storage section 62. The device-specific information is information in which each inspection portion (site to be inspected) on the wafer 1 is associated with the illumination conditions, such as the incident angle, emission wavelength, and azimuth angle of the illumination light, or with the semiconductor light-emitting device 54 or the semiconductor light-emitting device group suitable for illuminating the inspection portion, and which is used for the light-emission control section 52 to select the semiconductor light-emitting device 54 or the semiconductor light-emitting device group from the semiconductor light-emitting device array 51.

For example, the device-specific information may be stored as a table of information in which each inspection portion on the wafer 1 is directly associated with the semiconductor light-emitting device 54 or the semiconductor light-emitting device group suitable for illuminating the inspection portion. In this case, the light-emission control section 52 reads the storage section 62 to retrieve the device-specific information concerning the inspection portion currently located within the field of view of the objective lens 10. Then, the light-emission control section 52 selects the semiconductor light-emitting device 54 or the semiconductor light-emitting device group associated with that inspection portion.

The light-emission control section 52 outputs a signal indicating the selected semiconductor light-emitting device 54 or semiconductor light-emitting device group to the light-emitting device driving section 81. The light-emitting device driving section 81 is a driving circuit for supplying each semiconductor light-emitting device 54 with a driving current necessary for causing the semiconductor light-emitting device 54 to emit light, and can control the operation of each individual semiconductor light-emitting device 54 or each individual semiconductor light-emitting device group in the semiconductor light-emitting device array 51. Based on the instruction signal received from the light-emission control section 52, the light-emitting device driving section 81 turns on the selected semiconductor light-emitting device 54 or semiconductor light-emitting device group.

In another example, the device-specific information is table information in which each inspection portion on the wafer 1 is associated with the illumination conditions for that portion, for example, the incident angle, azimuth angle, and emission wavelength of the illumination light suitable for illuminating the inspection portion. In this case, the light-emission control section 52 reads the storage section 62 to retrieve the device-specific information concerning the inspection portion currently located within the field of view of the objective lens 10. Then, based on the light-emitting device attribute information, the light-emission control section 52 selects from the semiconductor light-emitting device array 51 from the semiconductor light-emitting device 54 capable of providing the illumination light that best matches the incident angle, azimuth angle, and emission wavelength of the illumination light associated with that inspection portion, and turns on the thus selected semiconductor light-emitting device 54.

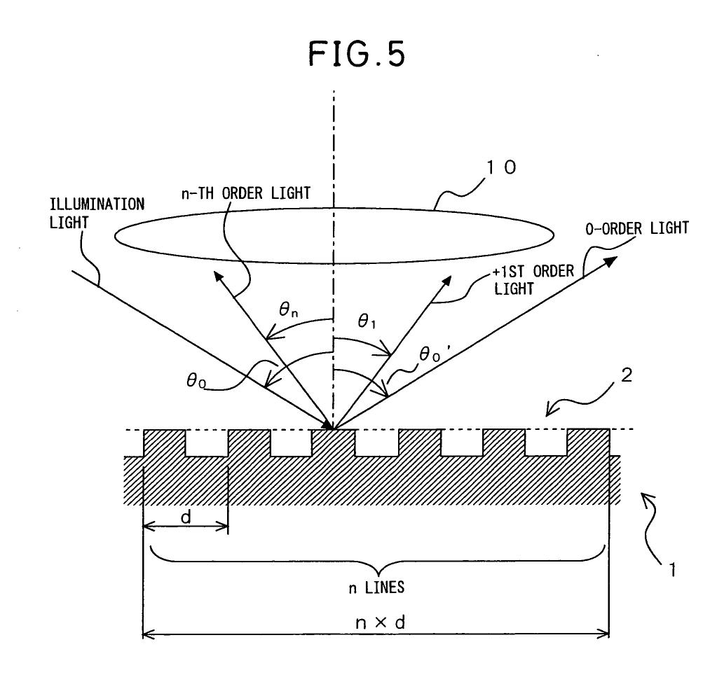

Further, the device-specific information may be stored as a table of information in which each inspection portion on the wafer 1 is associated with the repeat pitch (wiring pitch width) of the repeated pattern, such as a wiring pattern, formed on the inspection portion. The direction of the diffracted light diffracted at the repeated pattern portion such as a wiring pattern is dependent on the repeat pitch of the repeated pattern (the wiring pitch width of the wiring pattern), the incident angle of the incident light, and the wavelength of the incident light. The relationships among them are shown in FIG. 5.

FIG. 5 is a diagram showing the direction of reflection of the diffracted light diffracted by the repeated pattern 2. When light is incident on a pattern having a periodic structure with a given pitch d, the light is diffracted in the direction θₙ defined by
sin θ₀−sin θₙ=nλ/d
Here, θ₀ is the incident angle of the incident light, and θ₀′ is the diffraction angle of the zero-order diffracted light, where sin θ₀≠sin θ₀′. Further, n indicates the order (n=0, ±1, ±2, . . . ), and λ the wavelength of the incident light.

Accordingly, the light-emission control section 52 reads the storage section 62 to retrieve the repeat pitch width associated with the inspection portion located within the field of view of the objective lens 10 from the device-specific information for that portion. Based on the retrieved repeat pitch width and a known relative positional relationship between the objective lens 10 and the edge portion 2, the emission wavelength and incident angle suitable for illuminating the above pattern are computed from the above equation. Then, based on the light-emitting device-specific information, the semiconductor light-emitting device 54 or semiconductor light-emitting device group that best matches the thus computed emission wavelength and incident angle is selected from the semiconductor light-emitting device array 51, and the selected device or device group is turned on.

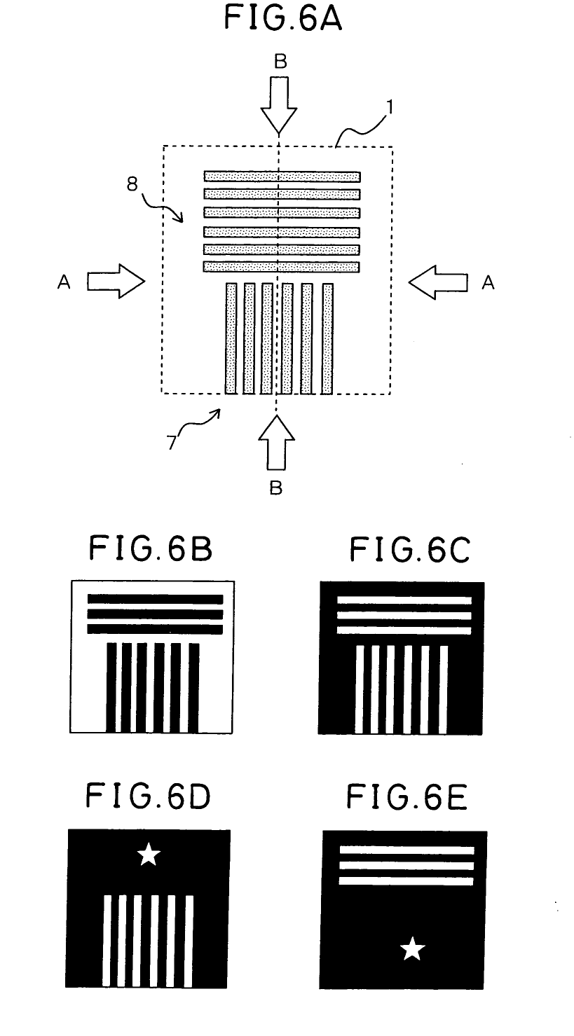

The device-specific information may be stored as table information in which each inspection portion on the wafer 1 is associated with the orientation of the wiring pattern formed on the inspection portion in the plane of the wafer 1. The sensitivity for detecting defects in the wiring pattern area depends on the angle that the direction of illumination (azimuth angle) of the illumination light makes with the direction of orientation (azimuth angle) of the wiring pattern in the plane of the wafer 1. This will be explained with reference to FIG. 6.

FIG. 6A is a top plan view of the wafer 1 having line patterns as wiring patterns, FIG. 6B shows an image captured when the wafer 1 is illuminated with bright-field illumination, FIG. 6C shows an image captured when the wafer 1 is illuminated with oblique illumination from directions A and B in FIG. 6A, FIG. 6D shows an image captured when the wafer 1 is illuminated with oblique illumination from the direction A, and FIG. 6E shows an image captured when the wafer 1 is illuminated with oblique illumination from the direction B.

In the bright-field image of FIG. 6B as well as the dark-field image of FIG. 6C, the sensitivity for detecting defects located between lines in the line pattern area 7 oriented in the direction B and the sensitivity for detecting defects located between lines in the line pattern area 8 oriented in the direction A both drop because of scattered light reflected at the edges of the line patterns. On the other hand, in the image captured under illumination from the direction A as shown in FIG. 6D, the scattered light from the line edges in the line pattern area 8 oriented in the direction A is suppressed, enhancing the sensitivity for detecting defects located between lines in the area 8; similarly, in the image captured under illumination from the direction B as shown in FIG. 6E, the scattered light from the line edges in the line pattern area 7 oriented in the direction B is suppressed, enhancing the sensitivity for detecting defects located between lines in the area 7.

Accordingly, the light-emission control section 52 reads the storage section 62 to retrieve the azimuth angle associated with the inspection portion located within the field of view of the objective lens 10 from the device-specific information for that portion, and obtains the azimuth angle of the illumination light projection (for example, the direction parallel to the associated direction) suitable for illuminating the wiring pattern oriented at that azimuth angle. Then, using the illumination conditions predetermined based on the light-emitting device-specific information, the suitable semiconductor light-emitting device 54 or semiconductor light-emitting device group is selected from the semiconductor light-emitting device array 51, and the selected device or device group is turned on. The light-emission control section 52 accomplishes the light-emission control by switching between predetermined light-emission patterns based on the position trigger information obtained from the moving stage 41.

The device-specific information may be stored as a table of information in which each inspection portion on the wafer 1 is associated with the material of the pattern formed on the inspection portion. In this case, the light-emission control section 52 reads the storage section 62 to retrieve the device-specific information concerning the inspection portion located within the field of view of the objective lens 10, and obtains the emission wavelength suitable for illuminating the material associated with that inspection portion. Then, based on the light-emitting device-specific information, the semiconductor light-emitting device 54 that best matches the thus obtained emission wavelength is selected from the semiconductor light-emitting device array 51, and the selected device is turned on. The light-emission control section 52 accomplishes the light-emission control by switching between predetermined light-emission patterns based on the position trigger information obtained from the moving stage 41.

Further, as will be described later, the device-specific information may include table data in which each inspection portion on the wafer 1 is associated with information concerning the density of the pattern formed on the inspection portion, flag information for identifying whether the inspection portion is a cell area, a logic circuit area, or a peripheral area, and/or flag information indicating whether or not the semiconductor light-emitting device array 51 is to be turned on for that inspection portion.

The device-specific information to be entered in advance via the input section 63 and stored in the storage section 62 for use by the light-emission control section 52 can be created based on results obtained by observing a sample wafer identical to the product wafer to be inspected.

The light-emission control section 52 may be configured to vary the amount of light emission of each selected semiconductor light-emitting device 54 individually by varying the current for driving the semiconductor light-emitting device 54.

Furthermore, the light-emission control section 52 can also be configured to select each individual semiconductor light-emitting device 54 or a group of semiconductor light-emitting devices 54 having the same incident angle, the same emission wavelength, or the same illumination azimuth angle, as earlier described, and to vary the amount of light emission of the semiconductor light-emitting device 54 or semiconductor light-emitting device group by varying the current for driving them. By the light-emission control section 52 thus varying the amount of light emission of the semiconductor light-emitting device 54, the amount of light emission of the illumination light for illuminating the test object can be changed, for example, for each incident angle, each emission wavelength, or each illumination azimuth angle.

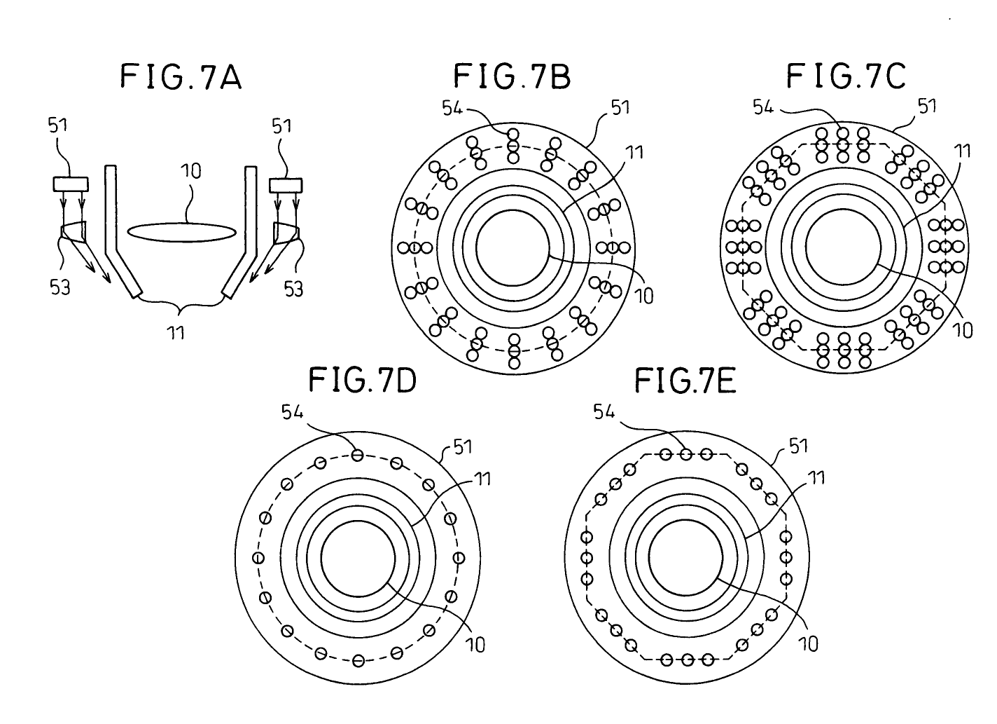

Various configurations can be employed for the mounting of the semiconductor light-emitting device array 51. For example, the semiconductor light-emitting device array 51 may be mounted inside the case 11 of the objective lens 10, as shown in FIGS. 4A to 4E, or may be mounted outside the case 11 of the objective lens 10, as shown in FIGS. 7A to 7E.

Further, various arrangements may be employed for the arrangement of the semiconductor light-emitting devices 54 in the semiconductor light-emitting device array 51. The semiconductor light-emitting devices 54 may be arranged as shown in FIG. 4B or 7B in a plurality of concentric circles (three circles in the figure) centered about the optical axis of the objective lens 10, or may be arranged as shown in FIG. 4C or 7C along the sides of a plurality of differently sized polygons (three polygons in the figure) having a common center at the optical axis of the objective lens 10. Alternatively, they may be arranged in a single circle centered about the optical axis of the objective lens 10, as shown in FIG. 4D or 7D, or may be arranged in straight lines and in a single row along the sides of a single polygon whose center coincides with the optical axis of the objective lens 10, as shown in FIG. 4E or 7E.

It will also be noted that the substrate of the semiconductor light-emitting device array 51 need not necessarily be formed in a circular ring shape, but may be formed in a polygonal ring shape. Furthermore, the semiconductor light-emitting device array 51 need not necessarily be mounted on a single substrate, but a plurality of substrates each having a semiconductor light-emitting device array mounted thereon may be arranged around the optical axis of the objective lens 10.

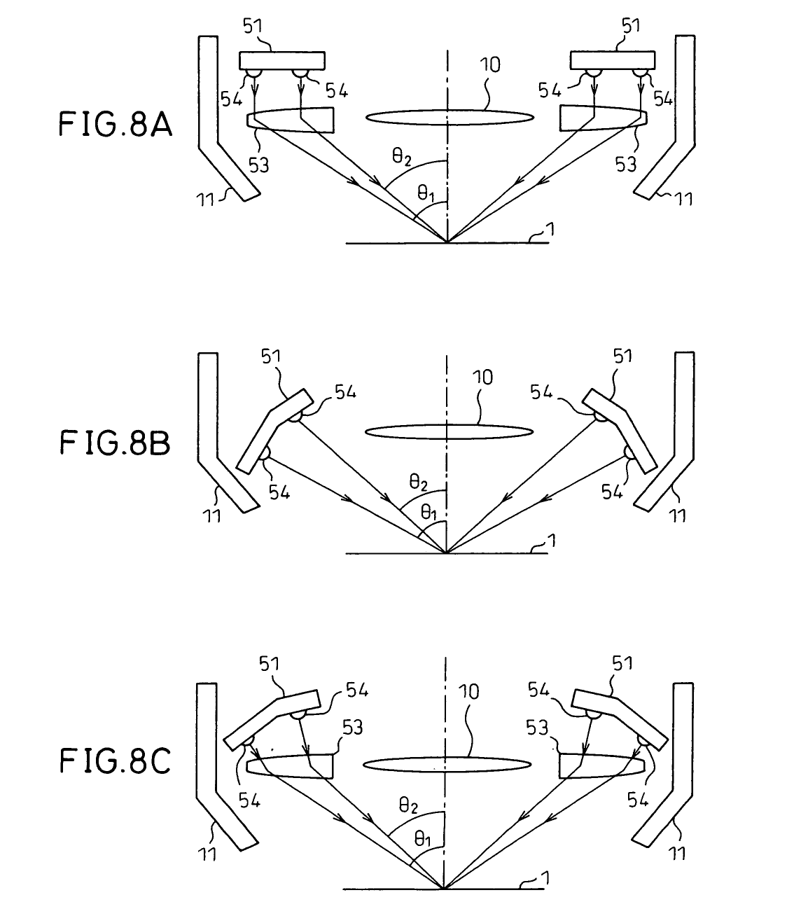

Various configuration can be employed in order to change the incident angle of the illumination light with respect to the wafer 1 for each semiconductor light-emitting device 54. Configuration examples are shown in FIGS. 8A to 8C. In the example of FIG. 8A, the semiconductor light-emitting devices 54 are mounted on the substrate of the semiconductor light-emitting device array 51 so that their strongest illumination directions (the principal illumination directions) are substantially parallel to each other. Then, the illumination lens 53 is mounted with its optical axis aligned parallel to the optical axis of the objective lens 10, and is formed so that the light incident on the illumination lens 53 at a point farther from its optical axis is refracted with a greater angle, thereby enabling any incident light to be focused to a single point.

That is, the illumination light from the semiconductor light-emitting device 54 mounted at a position nearer to the optical axis of the objective lens 10 enters the illumination lens 53 at a point nearer to its optical axis (as viewed in the radial direction) and is refracted with a smaller angle, so that the angle of incidence on the wafer 1 becomes smaller (deeper). Conversely, the illumination light from the semiconductor light-emitting device 54 mounted at a position farther from the optical axis of the objective lens 10 enters the illumination lens 53 at a point farther from its optical axis (as viewed in the radial direction) and is refracted with a greater angle by the illumination lens 53, so that the angle of incidence on the wafer 1 becomes larger (shallower) (θ1>θ2). In this way, the incident angle of the illumination light with respect to the wafer 1 can be changed for each semiconductor light-emitting device 54.

In the example of FIG. 8B, the angle that the perpendicular to the surface of the substrate of the semiconductor light-emitting device array 51 makes with the inspection surface of the test object is changed for each semiconductor light-emitting device 54 so that the incident angle of the illumination light on the wafer 1 differs for each semiconductor light-emitting device 54.

As shown, each semiconductor light-emitting device 54 is mounted on the substrate so that its optical axis coincides with the direction of the perpendicular dropped to the surface of the substrate of the semiconductor light-emitting device array 51. The substrate is formed so that the angle that the perpendicular to the substrate surface makes with the inspection surface (that is, the incident angle of the illumination light emitted from the semiconductor light-emitting device 54) decreases with decreasing distance from the optical axis of the objective lens 10, and so that the angle that the perpendicular makes with the inspection surface increases with increasing distance from the optical axis of the objective lens 10 (θ1>θ2).

In the example shown in FIG. 8C, the angle of incidence is changed in accordance with the distance between the semiconductor light-emitting device 54 and the optical axis of the objective lens 10, as in the example of FIG. 8A, while the substrate of the semiconductor light-emitting device array 51 on which each semiconductor light-emitting device 54 is mounted is formed in such a manner that the angle that the perpendicular to the substrate surface makes with the optical axis of the illumination lens 53 changes in accordance with the distance between the semiconductor light-emitting device 54 and the optical axis of the objective lens 10 (that is, the incident angle of the light emitted from the semiconductor light-emitting device 54 and entering the illumination lens 53 changes in accordance with the distance between the semiconductor light-emitting device 54 and the optical axis of the objective lens 10), as in the example of FIG. 8B.

By constructing the illumination lens 53 and the semiconductor light-emitting device array 51 as described above, it becomes possible to enlarge the range over which the angle of incidence on the test object is changed in accordance with the mounting position of each semiconductor light-emitting device 54; this serves to reduce the dimensions of the semiconductor light-emitting device array 51 and the illumination lens 53. This also provides a greater freedom in the mounting of the semiconductor light-emitting device array 51.

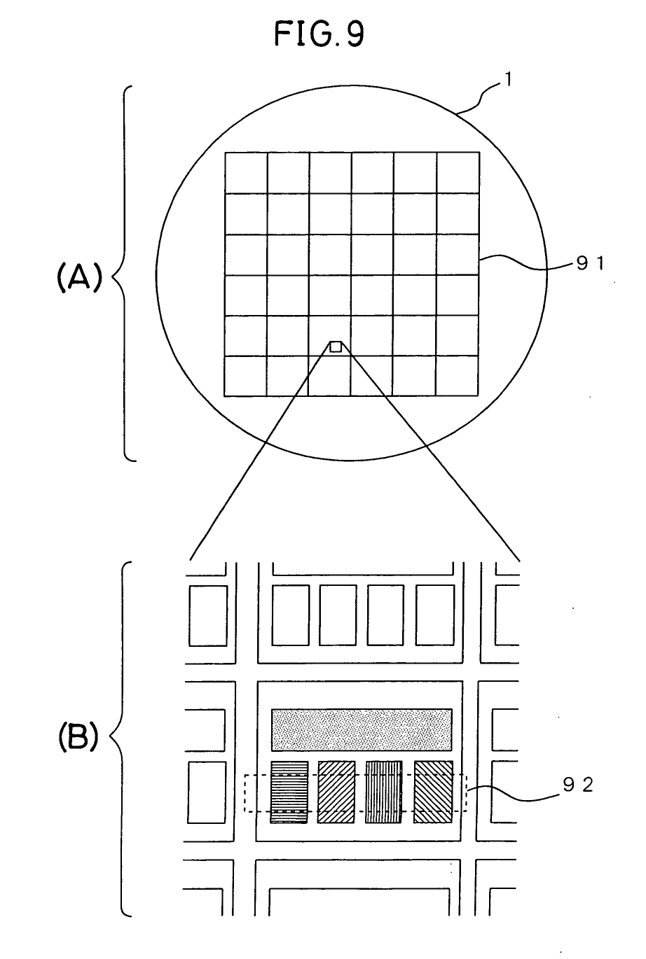

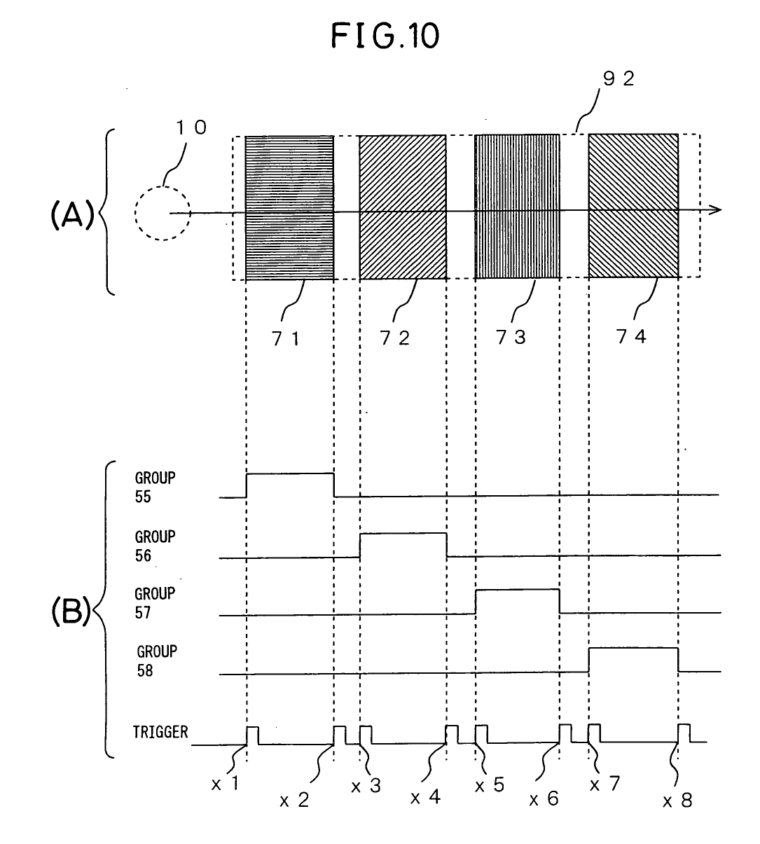

Next, referring to FIGS. 9 and 10, a description will be given of how the light emission of each semiconductor light-emitting device 54 is controlled during the semiconductor surface inspection when scanning the surface of the test object with the objective lens. FIG. 9 shows a top plan view of the semiconductor wafer as the test object and an enlarged view of a portion of the wafer. Part (A) of FIG. 9 shows the top plan view, and part (B) shows the enlarged view. FIG. 10 shows a timing chart for explaining how the light emission of each semiconductor light-emitting device 54 is controlled when scanning the field of view of the objective lens 10.

As shown in FIG. 9(A), a plurality of dies 91 on which circuit patterns are formed are fabricated on the semiconductor wafer 1. Further, as shown in FIG. 9(B), areas having various kinds of patterns are formed on each die 91; here, the case where the azimuth angle of the illumination light is changed by controlling the light emission of each semiconductor light-emitting device 54 when scanning the field of view of the objective lens 10 across the area 92 in the direction of the arrow shown in FIG. 10 will be considered. In the example of FIG. 10, areas 71 to 74 having wiring patterns oriented at various azimuth angles are formed within the area 92; the azimuth angle of the wiring pattern in the area 71 is 0°, the azimuth angle in the area 72 is 45°, the azimuth angle in the area 73 is 90°, and the azimuth angle in the area 74 is 135°.

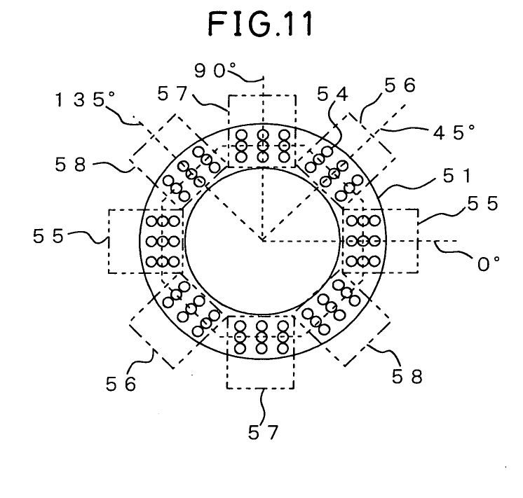

FIG. 11 is a diagram showing the arrangement of the semiconductor light-emitting devices 54 in the semiconductor light-emitting device array 51 used in the example of FIG. 10. The semiconductor light-emitting device array 51 of FIG. 11 has the same configuration as that of the semiconductor light-emitting device array 51 shown in FIG. 4C. Here, the semiconductor light-emitting devices 54 are organized into four groups, i.e., a group 55 (azimuth angle 0°), a group 56 (azimuth angle 45°), a group 57 (azimuth angle 90°), and a group 58 (azimuth angle 135°), according to the azimuth angle at which the wafer 1 is illuminated.

When the field of view of the objective lens 10 comes to the position x1 on the wafer 1 and thus enters the area 71, the light-emission control section 52 detects, based on the position information output from the stage control section 43, that the position x1 on the wafer 1 has come into the field of view of the objective lens 10. Then, the light-emission control section 52 obtains from the device-specific information stored in the storage section 62 the semiconductor light-emitting device group 55 suitable for illuminating the area 71. Alternatively, the light-emission control section 52 retrieves from the device-specific information the azimuth angle (0°) of the illumination light suitable for illuminating the area 71, and selects the semiconductor light-emitting device group 55 that provides the illumination light that matches the thus retrieved azimuth angle. Alternatively, the light-emission control section 52 retrieves from the device-specific information the azimuth angle (0°) of the wiring pattern in the area 71, obtains the azimuth angle (0°) of the illumination light suitable for illuminating the wiring pattern thus oriented, and selects the semiconductor light-emitting device group 55 that provides the illumination light that matches the thus obtained azimuth angle.

The light-emission control section 52 outputs an instruction signal for turning on the group 55 to the light-emitting device driving section 81 which thus turns on the semiconductor light-emitting devices 54 belonging to the semiconductor light-emitting device group 55. Then, as long as the field of view of the objective lens 10 is located within the area 71, the light-emission control section 52 continues to select the group 55, and the semiconductor light-emitting devices 54 belonging to that group continue to emit light.

Thereafter, when the field of view of the objective lens 10 moves relative to the wafer 1 and comes to the position x2, the light-emission control section 52 detects from the device-specific information stored in the storage section 62 that this area is a peripheral area, and stops selecting the semiconductor light-emitting devices 54 belonging to the semiconductor light-emitting device group 55 and turns them off.

Next, when the field of view of the objective lens 10 comes to the position x3 and thus enters the area 72, the light-emission control section 52 obtains from the device-specific information the semiconductor light-emitting device group 56 suitable for illuminating the area 72. Alternatively, the light-emission control section 52 retrieves from the device-specific information the azimuth angle (45°) of the illumination light suitable for illuminating the area 72, and selects the semiconductor light-emitting device group 56 that provides the illumination light that matches the thus retrieved azimuth angle. Alternatively, the light-emission control section 52 retrieves from the device-specific information the azimuth angle (45°) of the wiring pattern in the area 72, obtains the azimuth angle (45°) of the illumination light suitable for illuminating the wiring pattern thus oriented, and selects the semiconductor light-emitting device group 56 that provides the illumination light that matches the thus obtained azimuth angle.

In like manner, when the field of view of the objective lens 10 enters a peripheral area, the light-emission control section 52 turns off the semiconductor light-emitting devices 54, and when the field of view of the objective lens 10 enters the area 73, the light-emission control section 52 turns on the semiconductor light-emitting devices 54 belonging to the group 57; then, when the field of view of the objective lens 10 enters the area 74, the semiconductor light-emitting devices 54 belonging to the group 58 are turned on.

With the above operation, the azimuth angle of the illumination light can be changed during the surface inspection by changing the semiconductor light-emitting device group to be turned on in accordance with the position on the semiconductor wafer 1 that lies within the field of view of the objective lens 10 being scanned across the wafer. The incident angle of the illumination light or the wavelength of the illumination light can also be changed by changing the semiconductor light-emitting device group to be turned on in the same manner as described above.

In the example of the semiconductor light-emitting device group switching shown in FIG. 10, it has been described that the light-emission control section 52 turns off all the semiconductor light-emitting device groups 55 to 58 when the field of view of the objective lens 10 is located in the peripheral area, but alternatively, the light-emission control section 52 may be configured to turn on all the semiconductor light-emitting device groups 55 to 58 when the field of view of the objective lens 10 is located in the peripheral area.

Further, in the above configuration example, it has been described that the light-emission control section 52 constantly acquires from the stage control section 43 the position trigger information indicating the current position of the moving stage 41, acquires, based on the position information, the device-specific information for the area where the field of view of the objective lens is currently located, and continues to select the semiconductor light-emitting device group that matches the current area, but alternatively, the stage control section 43 may generate, based on the current position of the moving stage 41 and the device-specific information, a trigger for changing the semiconductor light-emitting device group to be turned on, and the light-emission control section 52 may change the semiconductor light-emitting device group to be turned on in accordance with the trigger.

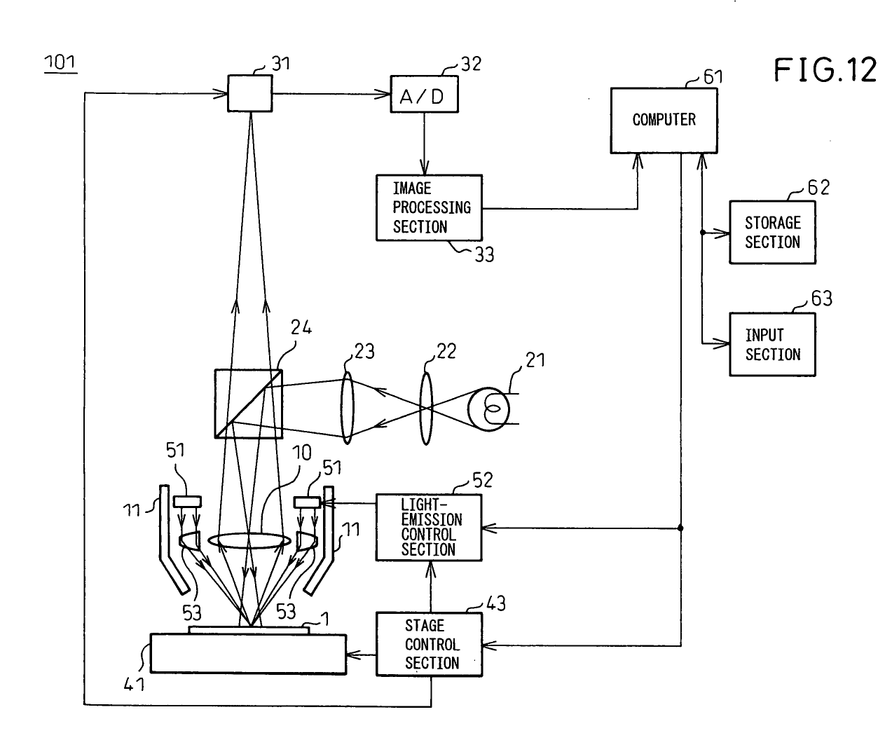

FIG. 12 is a schematic diagram showing the configuration of a semiconductor surface inspection apparatus according to a second embodiment of the present invention. The configuration of the semiconductor surface inspection apparatus according to this embodiment differs from that of the semiconductor surface inspection apparatus according to the first embodiment by the inclusion of a bright-field illumination means which comprises a bright-field light source 21, illumination lenses 22 and 23 for converging the illumination light emitted from the bright-field light source 21, and a beam splitter 24 for reflecting the illumination light.

The present embodiment is advantageously applied, among others, to the surface inspection of a test object such as a semiconductor wafer which contains a high-density pattern area such as a memory cell area (cell area) and a low-density pattern area such as its logic circuit area or peripheral circuit area (peripheral area) and in which, if the entire surface of the test object is illuminated with the same amount of light, the difference in brightness between the different areas becomes large. The following description is given by taking as an example of the test object a semiconductor wafer 1 having a cell area and a logic circuit area or peripheral area.

The illumination light produced by the bright-field illumination means is adjusted to a given level suitable for acquiring an image of the logic circuit area or peripheral area. Under such illumination, the image captured of the cell area is dark, and the defect detection sensitivity for the cell area decreases.

When scanning the wafer 1 with the imaging device 31 by moving the moving stage 41, the light-emission control section 52 performs control so that when the field of view of the objective lens 10 is located within the logic circuit area or peripheral area on the wafer 1, the semiconductor light-emitting device array 51 is turned off but, when the field of view of the objective lens 10 is located within the cell area, the semiconductor light-emitting device array 51 is turned on. That is, when the field of view of the objective lens 10 is located within the cell area, the illumination light produced by the bright-field illumination means and the illumination light produced by the semiconductor light-emitting device array 51 are simultaneously projected onto the test object, and the image of the thus illuminated test object is detected by the imaging device 31.

By thus controlling the light emission of the semiconductor light-emitting device array 51 depending on whether the field of view of the objective lens 10 is located in the cell area or in the peripheral area, an image produced by combining the image of the logic circuit area or peripheral area obtained under bright-field illumination with the image of the cell area, obtained under bright-filed illumination while enhancing defects by dark-field illumination, can be acquired in a single scan operation by the single imaging device 31, and the defect detection sensitivity for the cell area can be enhanced.

More specifically, the light-emission control section 52 acquires the position information of the moving stage 41 being constantly output from the stage control section 43. The device-specific information stored in the storage section 62 contains a table of information in which each inspection portion on the wafer 1 is associated with information concerning the density of the pattern formed on the inspection portion. The light-emission control section 52 reads the storage section 62 to retrieve the device-specific information concerning the inspection portion located within the field of view of the objective lens 10. Then, when the pattern density associated with the inspection portion is lower than a given threshold density, the semiconductor light-emitting device array 51 is turned off, but when the density is higher than the given threshold density, the semiconductor light-emitting device array 51 is turned on.

The device-specific information stored in the storage section 62 may be stored as a table of information in which each inspection portion on the wafer 1 is associated with flag information for identifying whether the inspection portion is a cell area, a logic circuit area, or a peripheral area. In this case, the light-emission control section 52 reads the storage section 62 to retrieve the device-specific information concerning the inspection portion located within the field of view of the objective lens 10. Then, when the flag information associated with the inspection portion indicates a logic circuit area or a peripheral area, the semiconductor light-emitting device array 51 is turned off, but when the flag information indicates a cell area, the semiconductor light-emitting device array 51 is turned on.

Alternatively, the device-specific information stored in the storage section 62 may be stored as a table of information in which each inspection portion on the wafer 1 is associated with flag information that simply indicates whether or not the semiconductor light-emitting device array 51 is to be turned on for that inspection portion. In this case, the light-emission control section 52 reads the storage section 62 to retrieve the device-specific information concerning the inspection portion located within the field of view of the objective lens 10. Then, the semiconductor light-emitting device array 51 is turned on or off in accordance with the device-specific information.

The light-emission control section 52 may perform control so as to turn off the bright-field light source 21 when the semiconductor light-emitting device array 51 is turned on. That is, the illumination means may be switched so that only the logic circuit area or peripheral area is illuminated with bright-field illumination, and so that only the cell area is illuminated with dark-field illumination by turning on the semiconductor light-emitting device array 51.

Alternatively, the light-emission control section 52 may perform control so that the logic circuit area or peripheral area is also illuminated by turning on the semiconductor light-emitting device array 51 in addition to the bright-field illumination means.

Further, the device-specific information may, as in the light-emitting device-specific information of the foregoing first embodiment, include a table of information in which each inspection portion within the cell area or the logic circuit area or peripheral area is associated with the semiconductor light-emitting devices 54 to be selected for illuminating the inspection portion.

Then, when illuminating the inspection portion within the cell area or the logic circuit area or peripheral area by the semiconductor light-emitting device array 51, the light-emission control section 52 may, as in the foregoing first embodiment, perform control so that, based on the device-specific information, suitable semiconductor light-emitting devices 54 are selected from the semiconductor light-emitting device array 51 and the selected light-emitting devices are turned on.

Further, the device-specific information may, as in the light-emitting device-specific information of the foregoing first embodiment, include a table of information in which each inspection portion within the cell area or the logic circuit area or peripheral area is associated with the incident angle, azimuth angle, and emission wavelength of the illumination light suitable for illuminating the inspection portion.

In this case, when illuminating the inspection portion within the cell area or the logic circuit area or peripheral area by the semiconductor light-emitting device array 51, the light-emission control section 52 may, as in the foregoing first embodiment, perform control so that, based on the device-specific information and the light-emitting device attribute information, the semiconductor light-emitting devices 54 that match the incident angle, azimuth angle, and emission wavelength of the illumination light suitable for illuminating the inspection portion are selected from the semiconductor light-emitting device array 51 and the selected light-emitting devices are turned on.

Further, the device-specific information may, as in the light-emitting device-specific information of the foregoing first embodiment, include a table of information in which each inspection portion within the cell area or the logic circuit area or peripheral area is associated with the attribute information of the pattern formed on the inspection portion, such as the repeat pitch of the repeated pattern formed on the inspection portion, the wiring pitch of the wiring pattern, the orientation of the line pattern in the plane of the wafer 1, or the material forming the pattern.

In this case, when illuminating the inspection portion within the cell area or the logic circuit area or peripheral area by the semiconductor light-emitting device array 51, the light-emission control section 52 may, as in the foregoing first embodiment, acquire based on the device-specific information the attribute information of the pattern formed on the inspection portion, obtain the incident angle, azimuth angle, and emission wavelength of the illumination light that match the attribute information, and select, based on the light-emitting device attribute information, the semiconductor light-emitting devices 54 to be turned on from the semiconductor light-emitting device array 51.

Further, as in the foregoing first embodiment, the light-emission control section 52 may be configured to vary the amount of light emission of each selected semiconductor light-emitting device 54 individually by varying the current for driving the semiconductor light-emitting device 54. Furthermore, the light-emission control section 52 can also be configured to select each individual semiconductor light-emitting device 54 or a group of semiconductor light-emitting devices 54 having the same incident angle, the same emission wavelength, or the same illumination azimuth angle, and to vary the amount of light emission of the semiconductor light-emitting device 54 or semiconductor light-emitting device group by varying the current for driving them.

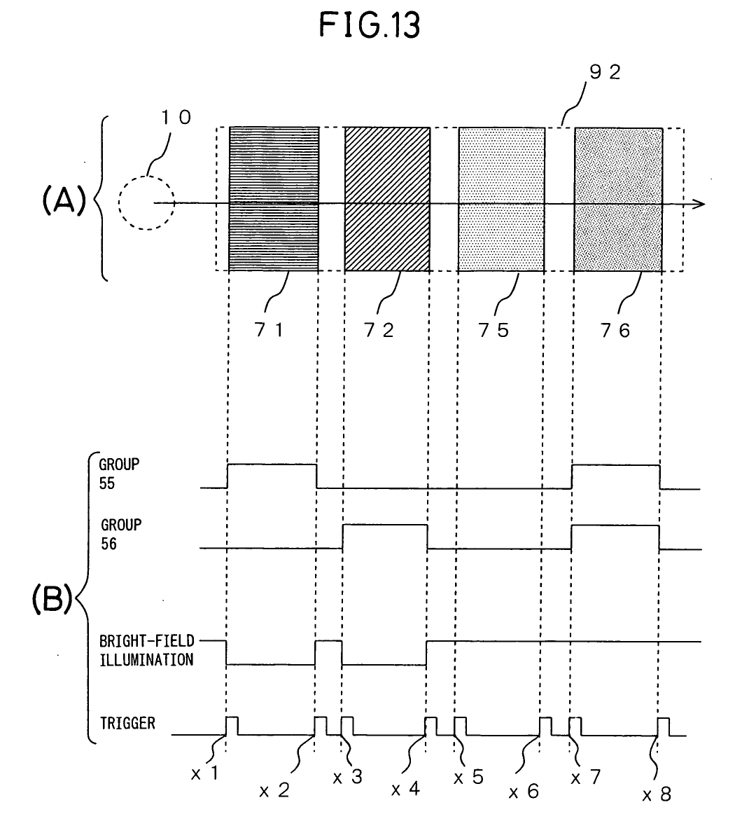

FIG. 13 is a timing chart for explaining how the light emission of the bright-field light source 21 and semiconductor light-emitting devices 54 is controlled when inspecting the surface of the area 92 on the semiconductor wafer 1 having cell areas, logic circuit areas, and peripheral areas. The cell areas 71 and 72 contain wiring patterns formed at azimuth angles of 0° and 45°, respectively, while the areas 75 and 76 are logic circuit areas.

Here, the case where the azimuth angle of the illumination light is changed by controlling the light emission of each semiconductor light-emitting device 54 and switching between bright-field illumination and dark-field illumination when scanning the field of view of the objective lens 10 across the wafer 1 in the direction of the arrow will be considered. The arrangement of the semiconductor light-emitting devices 54 is the same as that shown in FIG. 11.

Before the field of view of the objective lens 10 comes to the position x1 on the wafer 1, that is, when the field of view is located in the peripheral area, the light-emission control section 52 acquires the pattern density of the peripheral area from the device-specific information stored in the storage section 62, and selects the bright-field illumination means as the illumination suitable for that pattern density. Alternatively, the light-emission control section 52 recognizes from the device-specific information that the field of view of the objective lens 10 is currently located in the peripheral area, and selects the bright-field illumination means as the illumination suitable for illuminating the peripheral area.

Then, the light-emission control section 52 outputs to the light-emitting device driving section 81 an instruction signal for turning on the bright-field illumination means while keeping all the semiconductor light-emitting devices 54 turned off, and the light-emitting device driving section 81 thus turns on only the bright-field illumination means.

When the field of view of the objective lens 10 comes to the position x1 on the wafer 1 and thus enters the area 71, the light-emission control section 52 that detected this situation acquires the pattern density of the area 71 from the device-specific information stored in the storage section 62, and selects the dark-field illumination means (semiconductor light-emitting devices 54) as the illumination suitable for that pattern density. Alternatively, the light-emission control section 52 recognizes from the device-specific information that the area 71 is a cell area, and selects the dark-field illumination means as the illumination suitable for illuminating the cell area. Then, in the same manner as previously described with reference to FIG. 10, the semiconductor light-emitting device group 55 that provides the illumination light having the azimuth angle suitable for illuminating the area 71 is selected based on the device-specific information stored in the storage section 62, and the selected device group is turned on, while turning off the bright-field illumination means.

When the field of view of the objective lens 10 comes to the position x2 on the wafer 1 and thus enters the peripheral area again, the light-emission control section 52 that detected this situation recognizes from the device-specific information that the field of view of the objective lens 10 is currently located in the peripheral area, and turns on the bright-field illumination means while turning off the group 55. Then, when the field of view of the objective lens 10 comes to the position x3 on the wafer 1 and thus enters the area 72, the light-emission control section 52 recognizes that the area 72 is a cell area, and selects the dark-field illumination means; then, in the same manner as previously described with reference to FIG. 10, the light-emission control section 52 selects the semiconductor light-emitting device group 56 that provides the illumination light having the azimuth angle suitable for illuminating the area 72. When the field of view of the objective lens 10 comes to the position x4 on the wafer 1 and thus enters the peripheral area again, the light-emission control section 52 turns off the group 56 and turns on the bright-field illumination means again.

Thereafter, when the field of view of the objective lens 10 comes to the position x5 on the wafer 1 and thus enters the logic circuit area 75, the light-emission control section 52 that detected this situation acquires the pattern density of the area 75 from the device-specific information stored in the storage section 62, and selects the bright-field illumination means as the illumination suitable for that pattern density. Alternatively, the light-emission control section 52 recognizes from the device-specific information that the area 75 is a logic circuit area, and selects the bright-field illumination means as the illumination suitable for illuminating the logic circuit area. Then, the light-emission control section 52 keeps the bright-field illumination means turned on, while keeping the dark-field illumination means turned off.

Here, the light-emission control section 52 may also turn on the dark-field illumination means (semiconductor light-emitting devices 54) even when the field of view of the objective lens 10 is located in a logic circuit area. In the example of FIG. 13, the light-emission control section 52 turns on the semiconductor light-emitting device groups 55 and 56 as well as the bright-field illumination means in the logic circuit area 76 (x7 to x8). Further, when the field of view of the objective lens 10 is located in the peripheral area, the light-emission control section 52 may turn on the dark-field illumination means as needed, instead of the bright-field illumination means.

The present invention is applicable to surface inspection apparatus for inspecting semiconductor devices such as semiconductor wafers, semiconductor memory photomasks, liquid crystal panels, and the like.

While the preferred modes of the present invention have been described in detail above, it should be understood, by those skilled in the art, that various modifications and changes can be made by anyone skilled in the art, and that all of such modifications and changes that come within the range of the true spirit and purpose of the present invention fall within the scope of the present invention as defined by the appended claims.

1-42. (canceled)

43. A semiconductor surface inspection apparatus for inspecting a surface on a semiconductor device as a test object based on an optical image of said test object, comprising:
a semiconductor light-emitting device array formed by a plurality of semiconductor light-emitting devices for illuminating said test object obliquely with respect to an optical axis of an objective lens from a circumference centered about said optical axis, said circumference being contained in a plane perpendicular to said optical axis; and a light-emission control section for performing control so as to selectively turn on said semiconductor light-emitting devices in said semiconductor light-emitting device array.

44. A semiconductor surface inspection apparatus as claimed in claim 43, wherein said light-emission control section changes the amount of light emission of each individual one of said selectively turned-on semiconductor light-emitting devices.

45. A semiconductor surface inspection apparatus as claimed in claim 43, wherein
said semiconductor light-emitting device array is formed by a plurality of semiconductor light-emitting devices which are configured to provide beams of illumination light that fall on said test object at respectively different incident angles, and
said light-emission control section selectively turns on said semiconductor light-emitting devices thereby changing the incident angle of said illumination light with respect to said test object.

46. A semiconductor surface inspection apparatus as claimed in claim 45, further comprising a converging lens, placed between a light-emitting plane of said semiconductor light-emitting device array and said test object, for causing the illumination light from said semiconductor light-emitting device array to converge within the field of view of said objective lens, and wherein
said plurality of semiconductor light-emitting devices configured to provide beams of illumination light that fall on said test object at respectively different incident angles project said beams of illumination light at respectively different radial positions on said converging lens.

47. A semiconductor surface inspection apparatus as claimed in claim 45, wherein in said semiconductor light-emitting device array, said plurality of semiconductor light-emitting devices configured to provide beams of illumination light that fall on said test object at respectively different incident angles are arranged by varying an angle that the direction of light emission makes with the optical axis of said objective lens.

48. A semiconductor surface inspection apparatus as claimed in claim 43, wherein
said semiconductor light-emitting device array includes a plurality of semiconductor light-emitting devices having different emission wavelengths, and
said light-emission control section selectively turns on said semiconductor light-emitting devices thereby changing the wavelength of said illumination light for illuminating said test object.

49. A semiconductor surface inspection apparatus as claimed in claim 43, wherein
said semiconductor light-emitting device array includes a plurality of semiconductor light-emitting devices which are configured to provide beams of illumination light at respectively different azimuth angles to said test object, and
said light-emission control section selectively turns on said semiconductor light-emitting devices thereby changing the azimuth angle of said illumination light for illuminating said test object.

50. A semiconductor surface inspection apparatus for inspecting a surface on a semiconductor device as a test object based on an optical image of said test object, comprising:
a semiconductor light-emitting device array formed by a plurality of semiconductor light-emitting devices for illuminating said test object obliquely with respect to an optical axis of an objective lens from a circumference centered about said optical axis, said circumference being contained in a plane perpendicular to said optical axis; and a light-emission control section for selecting one or more semiconductor light-emitting devices from said semiconductor light-emitting device array and for changing the amount of light emission of said selected semiconductor light-emitting devices.

51. A semiconductor surface inspection apparatus as claimed in claim 50, wherein
said semiconductor light-emitting device array is formed by a plurality of semiconductor light-emitting devices which are configured to provide beams of illumination light that fall on said test object at respectively different incident angles, and
said light-emission control section changes the amount of light emission of said selected semiconductor light-emitting devices thereby changing the amount of incident light for each incident angle of said illumination light with respect to said test object.

52. A semiconductor surface inspection apparatus as claimed in claim 51, further comprising a converging lens, placed between a light-emitting plane of said semiconductor light-emitting device array and said test object, for causing the illumination light from said semiconductor light-emitting device array to converge within the field of view of said objective lens, and wherein
said plurality of semiconductor light-emitting devices configured to provide beams of illumination light that fall on said test object at respectively different incident angles project said beams of illumination light at respectively different radial positions on said converging lens.

53. A semiconductor surface inspection apparatus as claimed in claim 51, wherein in said semiconductor light-emitting device array, said plurality of semiconductor light-emitting devices configured to provide beams of illumination light that fall on said test object at respectively different incident angles are arranged by varying an angle that the direction of light emission makes with the optical axis of said objective lens.

54. A semiconductor surface inspection apparatus as claimed in claim 50, wherein
said semiconductor light-emitting device array includes a plurality of semiconductor light-emitting devices having different emission wavelengths, and
said light-emission control section changes the amount of light emission of said selected semiconductor light-emitting devices thereby changing the amount of incident light for each wavelength of said illumination light for illuminating said test object.

55. A semiconductor surface inspection apparatus as claimed in claim 50, wherein
said semiconductor light-emitting device array includes a plurality of semiconductor light-emitting devices which are configured to provide beams of illumination light at respectively different azimuth angles to said test object, and
said light-emission control section changes the amount of light emission of said selected semiconductor light-emitting devices thereby changing the amount of incident light for each azimuth angle of said illumination light for illuminating said test object.

56. A semiconductor surface inspection apparatus as claimed in claim 43 or claim 50, wherein said light-emission control section selects said semiconductor light-emitting devices so as to match a portion on said test object that is currently located in the field of view of said objective lens.

57. A semiconductor surface inspection apparatus as claimed in claim 56, wherein
said semiconductor surface inspection apparatus includes storage means for storing device-specific information which is predetermined for each portion of said test object and which specifies each of said semiconductor light-emitting devices to be turned on, and wherein
said light-emission control section performs control so as to switch between said semiconductor light-emitting devices in accordance with illumination conditions specified by said device-specific information for the portion currently located in the field of view of said objective lens.

58. A semiconductor surface inspection apparatus as claimed in claim 57, wherein said device-specific information includes information concerning repeat pitch width of a repeated pattern formed on said each portion of said test object.

59. A semiconductor surface inspection apparatus as claimed in claim 58, wherein said device-specific information includes information concerning pitch width of a wiring pattern formed on said each portion of said test object.

60. A semiconductor surface inspection apparatus as claimed in claim 57, wherein said device-specific information includes information concerning orientation of a line pattern formed on said each portion of said test object.

61. A semiconductor surface inspection apparatus as claimed in claim 57, wherein said device-specific information includes information concerning a material used to form a pattern on said each portion of said test object.

62. A semiconductor surface inspection apparatus as claimed in claim 56, wherein
said semiconductor surface inspection apparatus includes a moving stage for holding said test object thereon, said moving stage being capable of positioning each designated portion of said test object within the field of view of said objective lens, and wherein
based on position information of said moving stage, said light-emission control section identifies the portion of said test object that is currently located within the field of view of said objective lens.

63. A semiconductor surface inspection apparatus as claimed in claim 56, further comprising bright-field illumination means for illuminating said test object in a direction parallel to the optical axis of said objective lens.

64. A semiconductor surface inspection apparatus for inspecting a surface on a semiconductor device as a test object based on an optical image of said test object, comprising illumination means which includes:
bright-field illumination means for illuminating said test object in a direction parallel to an optical axis of an objective lens;
a semiconductor light-emitting device array formed by a plurality of semiconductor light-emitting devices for illuminating said test object obliquely with respect to the optical axis of said objective lens from a circumference centered about said optical axis, said circumference being contained in a plane perpendicular to said optical axis; and
a light-emission control section for controlling the light emission of said semiconductor light-emitting device array so as to match a portion on said test object that is currently located in the field of view of said objective lens.

65. An illumination method used in a semiconductor surface inspection apparatus for inspecting a surface on a semiconductor device as a test object based on an optical image of said test object, for illuminating said test object, wherein
control is performed so as to selectively turn on a plurality of semiconductor light-emitting devices contained in a semiconductor light-emitting device array which is configured to illuminate said test object obliquely with respect to an optical axis of an objective lens from a circumference centered about said optical axis, said circumference being contained in a plane perpendicular to said optical axis.

66. An illumination method as claimed in claim 65, wherein the amount of light emission of each of said selectively turned-on semiconductor light-emitting devices is controlled individually.

67. An illumination method as claimed in claim 65, wherein a plurality of semiconductor light-emitting devices contained in said semiconductor light-emitting device array, and configured to provide beams of illumination light that fall on said test object at respectively different incident angles, are selectively turned on thereby changing the incident angle of said illumination light with respect to said test object.

68. An illumination method as claimed in claim 65, wherein a plurality of semiconductor light-emitting devices contained in said semiconductor light-emitting device array and having different emission wavelengths are selectively turned on thereby changing the wavelength of illumination light for illuminating said test object.

69. An illumination method as claimed in claim 65, wherein a plurality of semiconductor light-emitting devices contained in said semiconductor light-emitting device array, and configured to provide beams of illumination light at respectively different azimuth angles to said test object, are selectively turned on thereby changing the azimuth angle of said illumination light for illuminating said test object.

70. An illumination method used in a semiconductor surface inspection apparatus for inspecting a surface on a semiconductor device as a test object based on an optical image of said test object, for illuminating said test object, wherein
a semiconductor light-emitting device is selected from among a plurality of semiconductor light-emitting devices contained in a semiconductor light-emitting device array configured to illuminate said test object obliquely with respect to an optical axis of an objective lens from a circumference centered about said optical axis, said circumference being contained in a plane perpendicular to said optical axis, and the amount of light emission of said selected semiconductor light-emitting device is changed.

71. An illumination method as claimed in claim 70, wherein said semiconductor light-emitting device is selected from said semiconductor light-emitting device array which comprises a plurality of semiconductor light-emitting devices configured to provide beams of illumination light that fall on said test object at respectively different incident angles, and the amount of light emission of said selected semiconductor light-emitting device is changed thereby changing the amount of incident light for each incident angle of said illumination light with respect to said test object.

72. An illumination method as claimed in claim 70, wherein said semiconductor light-emitting device is selected from said semiconductor light-emitting device array which comprises a plurality of semiconductor light-emitting devices having different emission wavelengths, and the amount of light emission of said selected semiconductor light-emitting device is changed thereby changing the amount of incident light for each emission wavelength of said illumination light for illuminating said test object.

73. An illumination method as claimed in claim 70, wherein said semiconductor light-emitting device is selected from said semiconductor light-emitting device array which comprises a plurality of semiconductor light-emitting devices configured to provide beams of illumination light at respectively different azimuth angles to said test object, and the amount of light emission of said selected semiconductor light-emitting device is changed thereby changing the amount of incident light for each azimuth angle of said illumination light for illuminating said test object.

74. An illumination method as claimed in claim 65, wherein said semiconductor light-emitting device is selected so as to match a portion on said test object that is currently located in the field of view of said objective lens.

75. An illumination method as claimed in claim 74, wherein
device-specific information which specifies each of said semiconductor light-emitting devices to be turned on is prestored for each portion of said test object, and wherein
control is performed by switching between said semiconductor light-emitting devices in accordance with illumination conditions specified by said device-specific information for the portion currently located in the field of view of said objective lens.

76. An illumination method as claimed in claim 75, wherein said device-specific information includes information concerning repeat pitch width of a repeated pattern formed on said each portion of said test object.

77. A semiconductor surface inspection apparatus as claimed in claim 75, wherein said device-specific information includes information concerning pitch width of a wiring pattern formed on said each portion of said test object.

78. An illumination method as claimed in claim 75, wherein said device-specific information includes information concerning orientation of a line pattern formed on said each portion of said test object.

79. An illumination method as claimed in claim 75, wherein said device-specific information includes information concerning a material used to form a pattern on said each portion of said test object.

80. An illumination method as claimed in claim 74, wherein the portion of said test object that is currently located within the field of view of said objective lens is identified based on position information of a moving stage which is provided in said semiconductor surface inspection apparatus and used to hold said test object and position each designated portion of said test object within the field of view of said objective lens.

81. An illumination method as claimed in claim 74, wherein bright-field illumination is performed which illuminates said test object in a direction parallel to the optical axis of said objective lens.

82. An illumination method used in a semiconductor surface inspection apparatus for inspecting a surface on a semiconductor device as a test object based on an optical image of said test object, for illuminating said test object, wherein
bright-field illumination is performed which illuminates said test object in a direction parallel to an optical axis of an objective lens, and
light emission of a semiconductor light-emitting device array comprising a plurality of semiconductor light-emitting devices for illuminating said test object obliquely with respect to the optical axis of said objective lens from a circumference centered about said optical axis, said circumference being contained in a plane perpendicular to said optical axis, is controlled so as to match a portion on said test object that is currently located in the field of view of said objective lens.

83. A semiconductor surface inspection apparatus as claimed in any one of claims 43, 50, or 64, wherein each individual one of said plurality of semiconductor light-emitting devices for illuminating said test object from the circumference centered about the optical axis of said objective lens, said circumference being contained in a plane perpendicular to said optical axis, is constructed from a group of a plurality of semiconductor light-emitting devices.

84. An illumination method as claimed in any one of claims 65, 70, or 82, wherein each individual one of said plurality of semiconductor light-emitting devices for illuminating said test object from the circumference centered about the optical axis of said objective lens, said circumference being contained in a plane perpendicular to said optical axis, is constructed from a group of a plurality of semiconductor light-emitting devices.
